(19) United States
(12) Patent Application Publication
(10) Pub. No.: US 2013/0297323 A1
(43) Pub. Date: Nov. 7, 2013

(54) SYSTEM AND METHOD FOR PROVIDING CLINICAL VIEWS OR RECOMMENDATIONS

(71) Applicant: Shahid N. Shah, Silver Spring, MD (US)

(72) Inventor: Shahid N. Shah, Silver Spring, MD (US)

(73) Assignee: Netspective Communications LLC, Silver Spring, MD (US)

(21) Appl. No.: 13/461,312

(22) Filed: May 1, 2012

(51) Int. Cl. G06Q 50/22

(52) U.S. Cl. 705/2

(57) ABSTRACT

A system configured to be accessed by a clinical provider and an external agency over a network. The system can include an input/output unit to receive an input external from the system and communicate an output. The system can include a database maintained within the system for storing information provided by or associated with the clinical provider and the external agency. The system can include a processing unit configured to assess a level of relevance of the clinical provider for an industry and define a numerical value defining potential of the clinical provider as an expert. The processing unit can be configured to allow access or deny from access as the clinical provider depending on at least one of the factors comprising the level of relevance to the industry and expertise level in a relevant field of the industry obtained based on the level of relevance.

### BACKGROUND

1. Technical Field

The embodiments herein generally relate to network access platforms, and, more particularly, to a healthcare networked platform accessible through a clinical provider profile.

2. Description of the Related Art

Online portals such as social networking sites and several other similar websites or portals have facilitated sharing views among friends, relatives, classmates, and other such entities forming a social group or community. The shared views help a person to benefit from other's ideas or views that are posted or shared within a group or a community. Moreover, a person can gauge the importance or relative benefit of something for oneself by reading views or posts or comments shared by others in a group. For example, a person can learn which laptop he should buy by reading posts or comments shared by his friends or group mates about that laptop. He can also view a rating that others provide in the group for the laptop he intends to purchase and therefore can be benefitted by their views. Thus, these methods provide a sort of online survey technique within a community.

One major problem in such cases is that the views shared within the group may not be authentic or reliable. There is a high possibility that even common persons without having relevant authority or knowledge regarding a particular aspect can wrongly impact the effect of online posts or comments. In such cases, it can even be possible that a correct and more important view gets rated lower than a wrong view. Further, with an objective of utilizing such portals or services in decision making processes such as for making clinical decisions, the use of the conventional modes of sharing views may not be appropriate and may affect correct decision making process.

Therefore, in light of the above, there is a need of a system and method for providing expert views such as clinical views via an online interface or portal such that the clinical views can be authenticated or assessed for reliability or accuracy.

### SUMMARY

In view of the foregoing, an embodiment herein provides a system configured to be accessed by a clinical provider and an external agency over a network. The system can include an input/output unit that receive an input external from the system and communicates an output. The output is received by any of the clinical provider and the external agency. The system can include a database maintained within the system for storing information provided by or associated with the clinical provider and the external agency. The system can include a processing unit that assesses a level of relevance of the clinical provider for an industry and defines a numerical value defining potential of the clinical provider as an expert. The processing unit can allow access or deny from access as the clinical provider depending on at least one factor comprising the level of relevance to the industry and expertise level in a relevant field of the industry obtained based on the level of relevance.

Another embodiment provides a web-based interface configured to be accessed through a common profile access by a clinical provider. The web-based interface can include a first section defined for posting views or comments of the clinical provider by the clinical provider. The web-based interface can include a gadget with the use of which the clinical provider tags an object into various categories defining preference levels. The web-based interface can include an analytics section that enables viewing analytics about tagging and posted comments to a clinical provider or an external agency. The analytics section can provide a summary of expert views in a field of interest.

Another embodiment provides a method of displaying an impact and weightage of clinical views posted over a network through a social networking service. The method can include receiving a clinical response from a clinical provider through an interface with the use of a gadget. The clinical provider can be authorized to submit the clinical response through a common clinical provider profile defined for experts of a relevant field. The method can include sorting the clinical response under at least one of defined categories. The method can include displaying, through a visual tag, a list categorizing frequency of responses under various categories based on the clinical response obtained from the clinical provider.

Another embodiment provides a non-transitory program storage device readable by a computer, and comprising a program of instructions executable by the computer to perform a method of displaying an impact and weightage of clinical views posted over a network through a social networking service. The method includes receiving a clinical response from a clinical provider through an interface with the use of a gadget. The clinical provider is authorized to submit the clinical response through a common clinical provider profile defined for experts of a relevant field. The method includes sorting the clinical response under at least one defined category. The method includes displaying, through a visual tag, a list categorizing frequency of responses under various categories based on the clinical response obtained from the clinical provider.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating a system according to an embodiment herein;

FIG. 2 is a block diagram illustrating a system accessed by a clinical provider and an external agency according to an embodiment herein;

FIG. 3 is a schematic diagram illustrating a first interface providing an interactive capability to a clinical provider according to an embodiment herein;

FIG. 4 is a schematic diagram illustrating a second interface providing an interactive capability to a clinical provider according to an embodiment herein;

FIG. 5 is a flow diagram illustrating a first method according to an embodiment herein;

FIG. 6 is a flow diagram illustrating a second method according to an embodiment herein; and

FIG. 7 is a block diagram illustrating a computer system according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

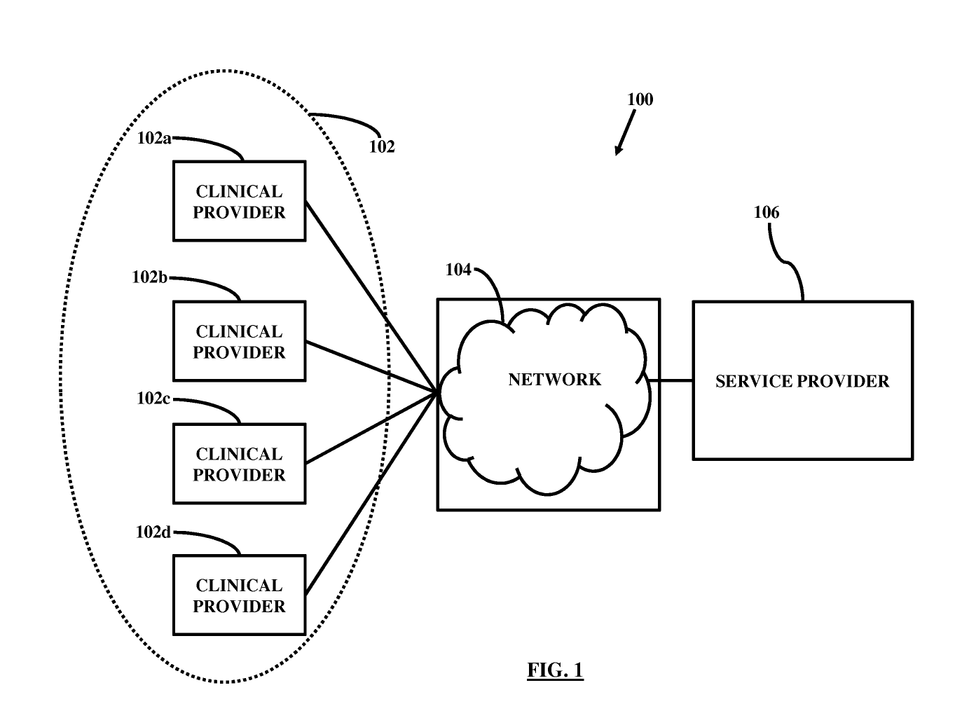

The embodiments herein provide a system and method for providing clinical reviews or recommendations. Referring now to the drawings, and more particularly to FIGS. 1 through 7, where similar reference characters denote corresponding features consistently throughout the figures, there are shown preferred embodiments.

FIG. 1 illustrates generally, but not by way of limitation, among other things, an example of an environment or architecture in which various embodiments herein may operate. As illustrated in FIG. 1, the environment comprises a plurality of clinical providers 102a, 102b, 102c, 102d, together referred to as 102, communicatively in connection with a service provider 106 over a network 104.

In an embodiment, the clinical providers 102 are recognized by authorities as field experts and their advice can be considered as a source of authentic information. In an embodiment, for example, the clinical providers 102 interacting over the network 104 can be provided with a National Provider Identifier (NPI) so as to ensure authenticity of the clinical providers 102 over the network 104. In such embodiments, the entire interaction over the network 104 can be entirely or partially NPI-based. Similarly, the clinical providers 102 can hold other types of licenses or be issued with other types of identifiers that can also define reliability and authenticity of the information generated by the clinical providers 102 in their respective field such as healthcare or medical fields.

In an embodiment, the service provider 106 can be a social networking service provider 106 configured to link several entities such as clinical providers over the network 104. In another embodiment, any other service provider 106 configured to communicatively connect the clinical providers 102 may also be employed. The clinical providers 102 can use the service provided by the service provider 106 to create or login to common profiles that can be used or viewed across an industry such as a healthcare industry as an example.

The network 104 can be a wireless or a wired network 104. The network 104 can operate as a communications network 104 configuring communication among the clinical providers 102 with the use of the service provided by the service provider 106. In an embodiment, the network 104 can be internet. The clinical providers 102 are capable of performing one or more of a number of processes over the network 104. The clinical providers 102 can be distributed over a wide area and can connect remotely among themselves over the network 104.

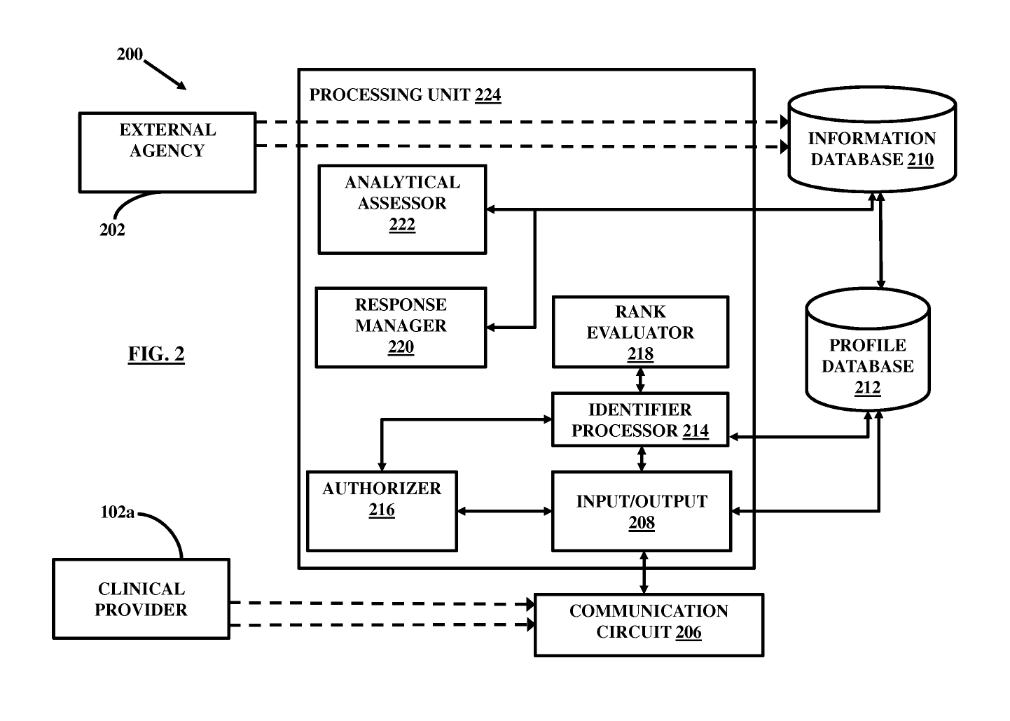

FIG. 2, with reference to FIG. 1, illustrates generally, but not by way of limitation, among other things, an example of a system 200 accessed by the clinical provider 102a and an external agency 202.

The clinical provider 102a has been discussed above with respect to FIG. 1. The external agency 202 can be any other user and not necessarily an expert of a particular field or industry. However, in some embodiments, the clinical provider 102a can also act as an external agency 202. A clinical provider such as clinical provider 102a and an external agency such as the external agency 202 are defined relative to a particular field of interest or expertise or industry. The difference between the clinical provider 102a and the external agency 202 can be understood from the example described below.

Supposing the environment as described in conjunction with FIG. 1 constitutes a medical environment wherein the plurality of clinical providers 102 are identified with their association and expertise in the field of medical science and research or related areas such as diagnostics, surgery, and so on. The external agency 202 operating in this environment may connect over the network 104 through the service provider 106 so as to gain insight in the medical area. The external agency 202 may not necessarily be defined as an expert in the field of medical science. In an embodiment, the external agency 202 can be a common person, a patient in need of medical advice, or a student who is conducting research, etc. In an embodiment, any of the clinical providers 102 can also act as an external agency 202 such as for confirming their medical decision or seeking suggestions from other experts, or for several other purposes.

The system 200 that can be deployed at the service provider 106 location can include or be coupled to a communication circuit 206. The communication circuit 206 can be configured to communicatively couple the plurality of clinical providers 102 and the external agency 202 with the system 200. The system can include a processing unit 224 that assesses a level of relevance of the clinical providers 102 for an industry and defines a numerical value defining a potential of the clinical provider 102 as experts. The processing unit 224 allows access or denies from access as the clinical providers 102 depending on at least one factor comprising the level of relevance to an industry and expertise level in a relevant field of the industry obtained based on the level of relevance.

The processing unit 224 can include an input/output unit 208 configured to be coupled to the communication circuit 206. The input/output unit 208 can be configured to receive an input external from the system 200 such as from the plurality of clinical providers 102 or the external agency 202 or generate an output or communicate an output generated by any other component within the system 200, wherein the output can be configured to be received by the clinical providers 102 or the external agency 202.

The system 200 can include an information database 210 maintained by the service provider 106 within the system 200 for maintaining or storing information generated or provided by the clinical providers 102 or the external agency 202 or information generated by manipulating data or information retrieved from the clinical providers 102 or the external agency 202. For example, the information database 210 can contain posts, feeds, comments, suggestions, remarks, etc. posted by the plurality of clinical providers 102 or the external agency 202. In an embodiment, the information database 210 can contain information related to statistical and analytical decisions derived from the information obtained from the plurality of clinical providers 102 or the external agency 202.

The system 200 can include a profile database 212 configured to store profiles of each of the clinical providers 102. In an embodiment, the profile database 212 can store biodata, expertise level, and information about authentication or certifications of the plurality of clinical providers 102. The profile database 212 can also store login credentials of each of the plurality of clinical providers 102. In an embodiment, the profile database 212 can store any information relevant to determining and assessing the potential and genuineness of a clinical provider in a particular industry such as the medical industry with respect to certain guiding parameters defining the relevancy and genuineness. The parameters can include educational qualification, professional experience, nature of professional engagement, seniority level in the related industry, reputation and recognition in the related industry, and several other such parameters.

The system 200 can include an identifier or a credential processor 214. The identifier processor 214 can be coupled to the profile database 212 and can be configured to receive information from the profile database 212 such as login credentials or any other such information. Based on the identifier or the credentials or the login information, the identifier processor 214 can be configured to allow a clinical provider access to the system 200. The identifier processor 214 can be configured to generate a notification indicating access or denial to the system 200. In an embodiment, the identifier processor 214 can include or be coupled to an authorizer 216 and can be configured to allow access or deny from access depending on various factors such as relevance to the industry or expertise level in the relevant field or industry.

The identifier processor 214 can be configured to be coupled to a rank evaluator 218. The rank evaluator 218 can be configured to assess the level of relevance of the clinical provider 102a for a specific industry and can provide a numerical value defining the potential of the clinical provider 102a as an expert. The higher the relevance or rank determined for a particular clinical provider, the greater the chances of a clinical provider getting access to the system 200 and thus getting an allowance for creating an online profile via the service provider 106.

FIG. 2 illustrates one clinical provider 102a and one external agency 202 interacting with the system 200. However, it must be appreciated that even more than one clinical provider 102 or external agency 202 can also interact simultaneously with the system 200 via the service provider 106. In an embodiment, hundreds, thousands, or millions of clinical providers or external agencies may interact with the system 200 such as through the Internet.

The system 200 includes an analytical assessor 222. The analytical assessor 222 can be configured to be coupled to the information database 210. The analytical assessor 222 can be configured to retrieve information from the information database 210 and generate various types of statistical outputs such as charts, graphs, functional relationships, or any other types of visual and statistical data. In an embodiment, the analytical assessor 222 can, for example, retrieve information about tagging of a particular object into various categories and can convert this information into a bar chart portraying number of experts against specific types of categories.

In an embodiment, the analytical assessor 222 is configured to be coupled to a response manager 220. The response manager 220 can be configured to validate responses or views. In an embodiment, the response manager 220 can associate or update or classify the responses or clinical views under various categories. The responses as updated by the response manager 220 can be stored in the information database 210 and displayed to a user through a visual tab (not shown). In an embodiment, the responses can be retrieved by the analytical assessor 222 directly from the response manager 220 to generate statistical reports or charts.

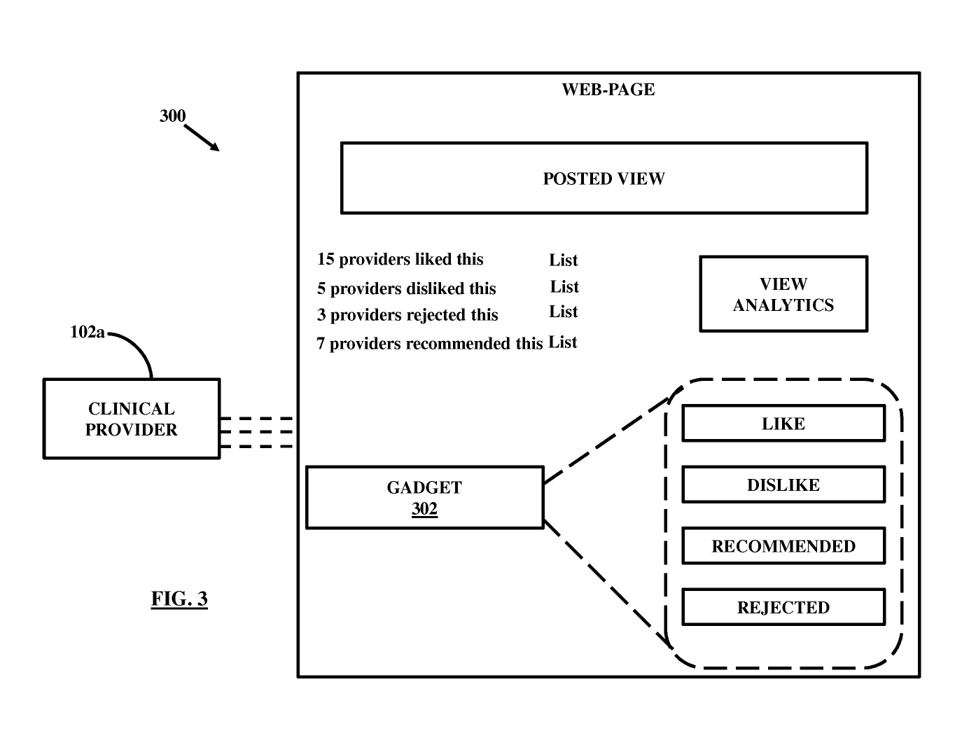

FIG. 3, with reference to FIGS. 1 and 2, illustrates generally, but not by the way of limitation, an example of an interface 300 providing a capability to the clinical provider 102a such as for providing clinical views among other things.

The interface 300 shown in FIG. 3 can be accessed through a common profile access. The profile can be termed as “clinical provider profile” that can be used across a medical or clinical industry. In an embodiment, the clinical provider profile or simply the profile can be accessed via a login credential that can be defined for a user such as the clinical provider 102a or the external agency 202 or any other user and defined only for a specific profile associated with a specific industry.

In an embodiment, the interface 300 may include a section to depict “posted views” posted or updated by the clinical provider 102a. In an embodiment, the interface 300 can provide a gadget 302 with the use of which the clinical provider 102a can tag an object such as particular article, element, process, design, apparatus, method of surgery, method of diagnose or any other object into various categories. The gadget 302 may be implemented through computer programs or software. In one embodiment the gadget 302 is software enabled. In another embodiment, the gadget 302 can be a widget such as provided as an element of a graphical user interface (GUI). The gadget 302 can provide an interaction point for the clinical providers 102. The various categories may include items such as “like”, “dislike”, “recommended”, “rejected”, or others. The clinical provider 102a can click on the gadget 302 upon which list of available options of tagging are presented in front of the clinical provider 102a. The clinical provider 102a can then click on any of the options representing the categories and accordingly provide clinical views through tagging. In an embodiment, the clinical provider 102a can post text or comments such as the posted views or posted clinical views. In an embodiment, the clinical provider 102a can post comments as well as tag the object in any of the categories. It must be appreciated that the clinical views by the clinical provider 102a through tagging or by writing can be considered as expert views as the clinical providers 102 are checked for authenticity and are given access only upon meeting standards of expertise in the relevant fields or industries. The tagging of an object into various categories can define preference levels of a clinical provider.

The interface 300 can generate or provide statistics of tagging by the plurality of clinical providers 102 such as shown in FIG. 3. FIG. 3 indicates in an example that 15 clinical providers liked a particular object, 5 disliked it, 3 rejected it, and 7 recommended it. The external agency 202 can use this information for deriving an insight into the object and can accordingly take a decision. List options can be provided along with the tagging statistics to show names or other demographic information about the clinical providers 102 under a particular category of tagging. In an embodiment, the interface 300 can provide an option of generating detailed analytics such as through a separate button or gadget “view analytics” that would enable someone to view analytics about tagging and posted comments. The interface 300 can include an analytics section that contains information or gadgets regarding viewing or generating analytics or statistical data. The “view analytics” option can create or show historical records as well in an embodiment. In an embodiment, the records retrieved from the “view analytics” button can be displayed in the form of text or in the form of charts or graphs. A summary of the records can also be generated for the analytical records. In an embodiment, the analytics section can provide a summary of expert views in a field of interest.

It must be appreciated that the gadget 302 can be operated only by experts such as the clinical providers 102 while the options like “List” and “View Analytics” can be operated by either the external agency 202 or the clinical providers 102. For example, the external agency 202 can know of expert suggestions about an object by looking at the tagging statistics and the view analytics options. However, the external agency 202 cannot post a view or tag an object because of lack of expertise in an associated industry and non-registration as the expert clinical provider 102a. It must be appreciated that the options such as “List” and “View Analytics” can be used by any user or a person who subscribes to the service provided by the service provider 106 such as a social networking service provider. However, for registering as the clinical provider 102a who receives additional options on the interface 300 and a dedicated clinical provider profile, the clinical provider 102a may require undergoing a registration process and/or an authentication process.

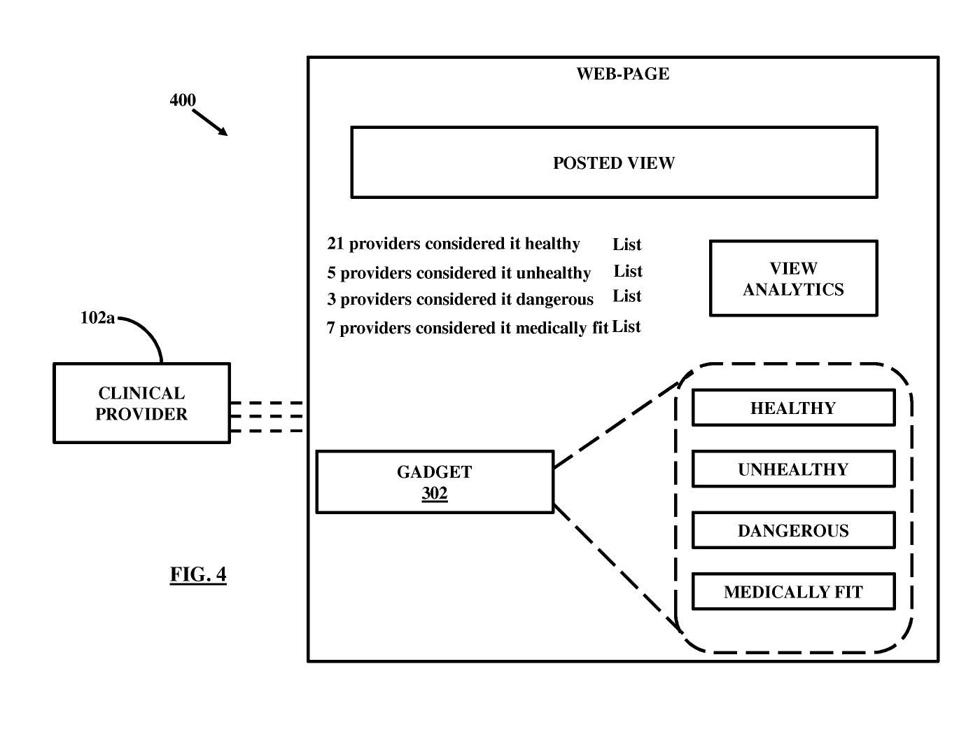

FIG. 4, with reference to FIGS. 1 through 3, illustrates generally, but not by the way of limitation, another example of an interface 400 providing a capability to the clinical provider 102a such as for providing clinical views among other things.

In accordance with the interface 400 depicted in FIG. 4, the categories may be more customized with respect to the industry such as the medical industry as an example here. In an embodiment of the medical industry, the object can be tagged such as healthy, unhealthy, dangerous, medically fit, or others. Accordingly, the tagging statistics can be indicated in the form of these categories: healthy, unhealthy, dangerous, and medically fit.

The embodiments illustrated in FIGS. 3 and 4 illustrated only one clinical provider 102. However, it must be appreciated that the interface 300 or 400 can be accessed be several clinical providers 102 and by several external agencies 202 separately via separate login credentials.

In an embodiment, the clinical provider 102a can share clinical views by tagging or posting comments as discussed above. In an embodiment, the clinical provider can provide + or − ratings to the object to indicate their acceptance or rejection. For example, +1, +2, −1, −2 and so on can be such rating indicators.

In an embodiment, the interfaces 300 or 400 as shown in FIG. 3 and FIG. 4, respectively, are provided as standalone interfaces by the service provider 106 through a dedicated networking service such as a social networking service. In an embodiment, the interfaces 300 or 400 or a portion of the capabilities provided by the interfaces 300 or 400 such as the gadget 302 can be provided over any web-page or applications or any other resources.

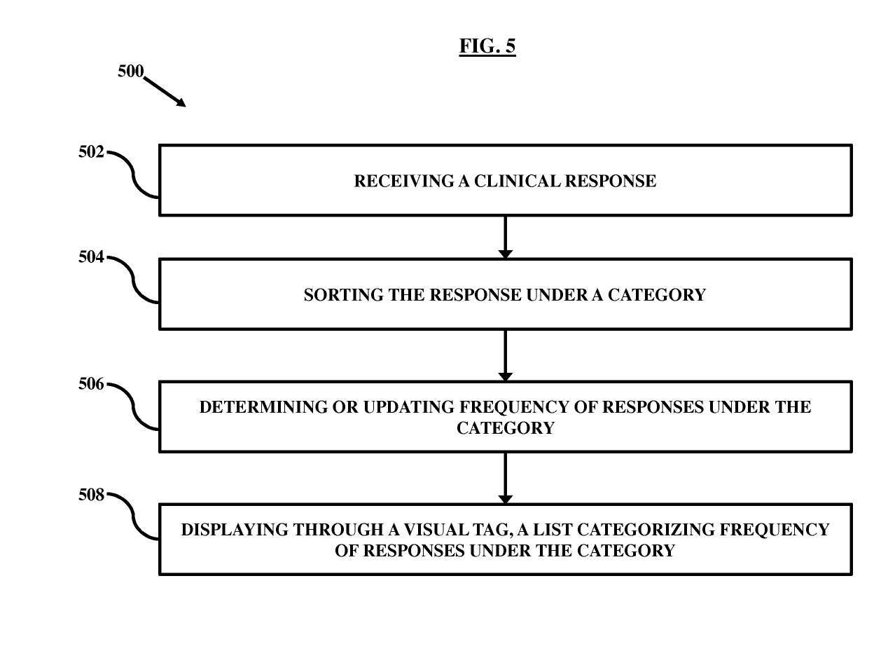

FIG. 5, with reference to FIGS. 1 through 4, is a flow diagram illustrating generally, but not by way of limitation, an example method 500 of displaying an impact and weightage of clinical views.

At step 502, the method can include receiving a clinical response. The clinical response can be provided by a clinical service provider 106 through the interface 300 or 400 with the use of the gadget 302 as described above in conjunction with FIGS. 3 and 4.

At step 504, the method can include sorting the clinical response received at step 502 under a category. The categories have already been described above. Thus, any clinical response can be categorized under any of the defined categories by such as the service provider 106.

At step 506, the method can include determining or updating the frequency of clinical responses or clinical views under the category. Subsequently, the method at step 508 can include displaying, through a visual tag, a list categorizing frequency of the responses or views under various categories. The visual tag or the list can be easily viewed by the plurality of clinical providers 102 or the external agency 202. With the use of the list, the weightage of the clinical views or responses can be determined or identified. The higher the frequency of the clinical view under a category, the higher the weightage of that category. The highest weightage category can, in an embodiment, be considered as the most authentic or the most respected decision by the experts in a particular field or industry that is defined by the categorization.

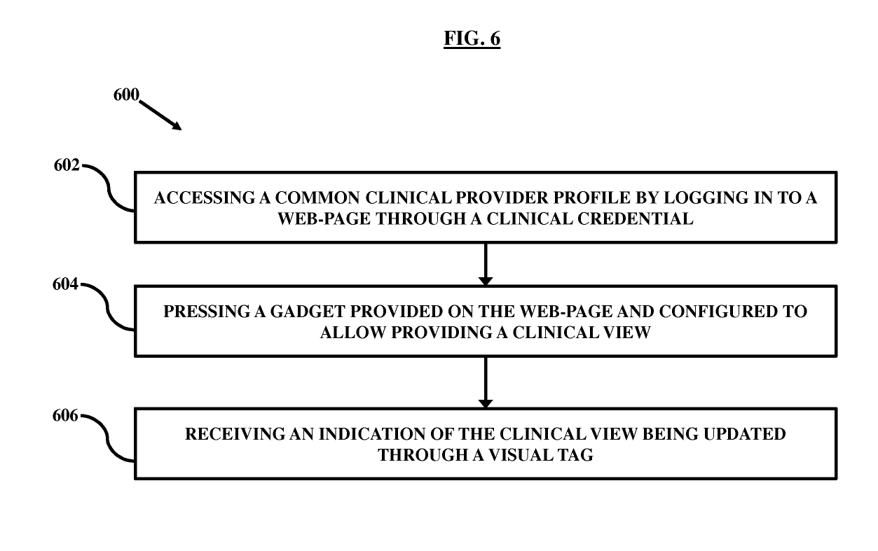

FIG. 6, with reference to FIGS. 1 through 5, illustrates generally, but not by way of limitation, an example method 600 of accessing a clinical provider profile for providing clinical views.

At step 602, the method can include accessing the common clinical provider profile by logging into a web-page through the clinical credential. The logging step can be performed with the use of the interface 300 or the interface 400 or any other web-page or application or resource providing a capability of the gadget 302 as discussed above.

At step 604, the method can include pressing the gadget 302 provided on the web-page or any other resource that is configured to allow providing of the clinical view. In an embodiment, only the clinical providers 102 that are experts in a particular and defined industry can be allowed to access the facility of providing the clinical view through the gadget 302.

Once the clinical view is provided, the method can include, in step 606, receiving an indication of the clinical view being updated through a visual tag. The clinical provider 102 can view the visual tag as indicating updated view. In a manner similar to posting the clinical view, clinical comments or remarks may also be posted that can also be identified as updated through an indicator such as similar to the visual tag.

In an example, the present document can provide a computer program product configured to include a pre-configured set of instructions, which when performed, can result in actions as stated in conjunction with the method 500 or 600 described above. In an example, the pre-configured set of instructions can be stored on a tangible non-transitory computer readable medium. In an example, the tangible non-transitory transitory computer readable medium can be configured to include the set of instructions, which when performed by a device, can cause the device to perform acts similar to the ones described here.

Embodiments within the scope of the present disclosure may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network 104 or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network 104 environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network 104). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network 104 adapters may also be coupled to the system to enable the data processing system to become coupled to other data processing systems or remote printers or storage devices through intervening private or public network 104s. Modems, cable modem and Ethernet cards are just a few of the currently available types of network 104 adapters.

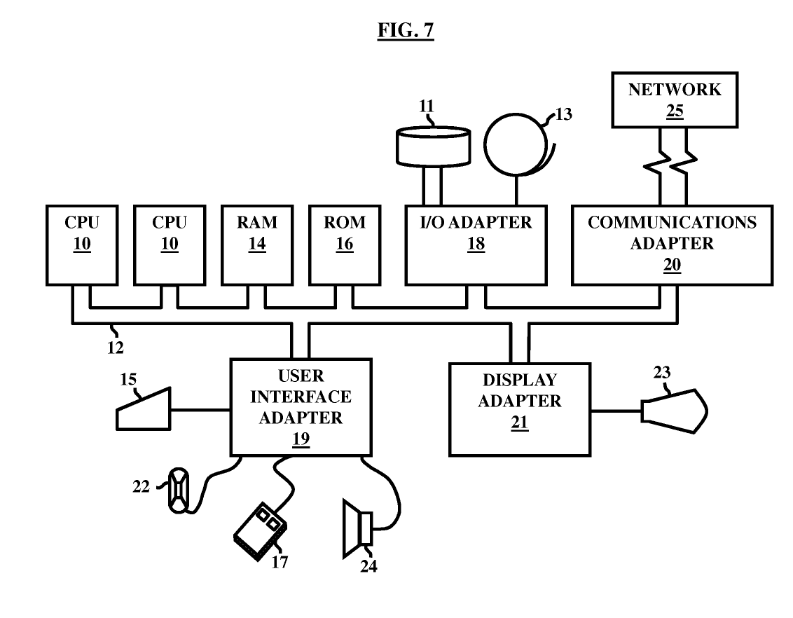

A representative hardware environment for practicing the embodiments herein is depicted in FIG. 7. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 104 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system configured to be accessed by a clinical provider and an external agency over a network, said system comprising:
an input/output unit that receives an input external from said system and communicates an output, wherein said output is received by any of said clinical provider and said external agency;
a database maintained within said system, wherein said database stores information provided by or associated with said clinical provider and said external agency; and
a processing unit that:
assesses a level of relevance of said clinical provider for an industry and defines a numerical value defining a potential of said clinical provider as an expert; and
allows access or denies from access as said clinical provider depending on at least one factor comprising said level of relevance to said industry and expertise level in a relevant field of said industry obtained based on said level of relevance.

2. The system of claim 1, further including a communication circuit that communicatively couples said clinical provider and said external agency with said system.

3. The system of claim 1, wherein said database comprises an information database maintained within said system, wherein said database maintains and stores information generated or provided by said clinical provider or said external agency, or information generated by manipulating data or information retrieved from said clinical provider or said external agency.

4. The system of claim 1, wherein said database comprises a profile database and configured to store profile of said clinical provider.

5. The system of claim 4, wherein said profile database stores at least one of biodata, expertise level, and information about authentication or certifications of said clinical provider.

6. The system of claim 5, further including a credential processor coupled to said profile database, wherein said credential processor receives information from said profile database so as to decide allowance or denial of said clinical provider with said system, said access or denial being dependent on any of educational qualification, professional experience, nature of professional engagement, seniority level in a related industry, and reputation and recognition in said related industry.

7. The system of claim 1, further including a rank evaluator that assesses a level of relevance of said clinical provider for an industry and associates with a numerical value defining a potential of said clinical provider as being an expert.

8. A web-based interface configured to be accessed through a common profile access by a clinical provider, said web-based interface comprising:
first section defined for posting views or comments of said clinical provider by said clinical provider;
a gadget with the use of which said clinical provider tags an object into various categories defining preference levels;
an analytics section that enables viewing analytics about tagging and posted comments to a clinical provider or an external agency, wherein said analytics section provides a summary of expert views in a field of interest.

9. The web-based interface of claim 8, wherein said various categories includes one or more of like, dislike, recommended, and rejected.

10. The web-based interface of claim 8, wherein said various categories includes one or more of healthy, unhealthy, dangerous, and medically fit.

11. The web-based interface of claim 8, further comprising a second section that displays demographic information about said clinical provider under a particular category of tagging.

12. A method of displaying an impact and weightage of clinical views posted over a network through a social networking service, said method comprising:
receiving a clinical response from a clinical provider through an interface with the use of a gadget, said clinical provider being authorized to submit said clinical response through a common clinical provider profile defined for experts of a relevant field;
sorting said clinical response under at least one defined category; and
displaying, through a visual tag, a list categorizing frequency of responses under various categories based on said clinical response obtained from said clinical provider.

13. The method of claim 12, further comprising updating said frequency of said clinical responses under said at least one defined category based on said clinical response and associated categories.

14. The method of claim 12, further comprising accessing said common clinical provider profile by logging into a web-page through a clinical credential.

15. The method of claim 12, further comprising accessing an indication of the clinical response being updated through said visual tag.

16. A non-transitory program storage device readable by a computer, and comprising a program of instructions executable by said computer to perform a method of displaying an impact and weightage of clinical views posted over a network through a social networking service, said method comprising:
receiving a clinical response from a clinical provider through an interface with the use of a gadget, said clinical provider being authorized to submit said clinical response through a common clinical provider profile defined for experts of a relevant field;
sorting said clinical response under at least one defined category; and
displaying, through a visual tag, a list categorizing frequency of responses under various categories based on said clinical response obtained from said clinical provider.

17. The program storage device of claim 16, wherein said method further comprises updating said frequency of said clinical responses under said at least one of said defined categories based on said clinical response and associated categories.
